(19) United States
(12) Patent Application Publication
(10) Pub. No.: US 2015/0178676 A1
(43) Pub. Date: Jun. 25, 2015

(54) Remote Delivery Systems And Methods

(71) Applicant: Wal-Mart Stores, Inc., Bentonville, AR (US)

(72) Inventors: David Jon Carr, Mountain View, CA (US); Richard Mark Ramsden, Foster City, CA (US)

(73) Assignee: Wal-Mart Stores, Inc., Bentonville, AR (US)

(21) Appl. No.: 14/136,445

(22) Filed: Dec. 20, 2013

(51) Int. Cl. G06Q 10/08

(52) U.S. Cl. CPC G06Q 10/0836; G06Q 10/0832

(57) ABSTRACT

Example systems and methods for delivering products are described. In one implementation, a request is received from a user to deliver an order to a remote pick-up location. The order includes a first item requiring refrigeration and a second item that is temperature-independent. A method identifies multiple remote pick-up locations convenient to the user and communicates the identified locations to the user. A delivery of the order is scheduled for a particular remote pick-up location selected by the user. The user is notified of a pick-up time window to access the order at the particular remote pick-up location. An access code associated with the order is generated and communicated to the user. The access code allows the user to access the order at the particular remote pick-up location during the pick-up time window.

### TECHNICAL FIELD

The present disclosure relates to systems and methods that facilitate delivery of items to users at a remote location.

### BACKGROUND

Customers often purchase items that need to be delivered to the customer. For example, items can be shipped using a parcel delivery service or mail service. Additionally, a merchant may deliver items to the customer using merchant delivery trucks or other local delivery services. In some situations, the customer may not want items delivered to their residence. For example, the customer may not be home to accept the delivery and does not want the items left at the door or the items may be refrigerated or frozen items that need to be stored in a refrigerated or frozen area. Additionally, customers may not be able to receive deliveries at work. Therefore, these customers experience difficulties when attempting to receive items that cannot be left at their home or office.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a delivery management system.

FIG. 3 is a flow diagram depicting an embodiment of a method for scheduling delivery of an order to a remote pick-up location.

FIG. 4 is a flow diagram depicting an embodiment of a method for selecting a remote pick-up location.

FIGS. 5A and 5B represent a flow diagram depicting an embodiment of a method for determining available pick-up time windows for an order.

FIG. 6 is a block diagram depicting an example computing device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein manage the delivery of items purchased from a merchant to a remote pick-up location. Additionally, the described systems and methods manage scheduling of the delivery of the items from the merchant to a particular remote pick-up location such that the customer (also referred to herein as a “user”) can retrieve the items from the remote pick-up location during a specific time window. In some embodiments, the items delivered to the remote pick-up location include refrigerated items, frozen items, and temperature-independent items. As used herein, a remote pick-up location (or remote location) refers to a physical location that is separate from a merchant store. In some embodiments, the remote pick-up location is a short distance (e.g., a few hundred feet) from the merchant store. In other embodiments, the remote pick-up location is a significant distance (e.g., ten or more miles) from the merchant store. In alternate embodiments, the remote pick-up location can be any distance from the merchant store.

An example remote pick-up location includes multiple lockers or other storage devices in which items are stored in a secured manner (e.g., with a locking mechanism). In some embodiments, each of the multiple lockers is configured to store refrigerated items, frozen items or temperature-independent items. The remote pick-up location may be a parking lot, warehouse, shopping center or any other area or structure capable of maintaining lockers that are accessible by delivery personnel and customers.

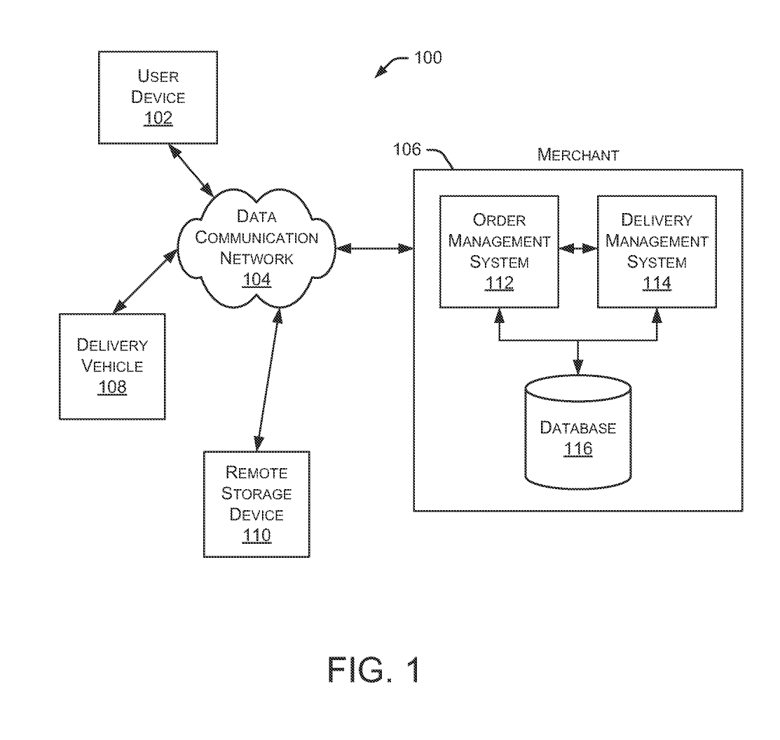

FIG. 1 is a block diagram depicting an environment 100 within which an example embodiment may be implemented. Environment 100 includes a user device 102 coupled to a data communication network 104, such as the Internet. Although one user device 102 is shown in FIG. 1, particular embodiments may include any number of user devices. User device 102 includes any type of device capable of communicating with other devices and systems through data communication network 104. An example user devices 102 includes a cellular phone, a smart phone, a tablet computer, a laptop computer, a desktop computer, a portable entertainment device, a portable gaming device, a set top box, and the like. Data communication network 104 may utilize any communication protocol and any type of communication medium. In some embodiments, data communication network 104 is a combination of two or more networks coupled to one another.

A merchant 106, a delivery vehicle 108, and a parcel remote storage device 110 are also coupled to data communication network 104. In some embodiments, merchant 106 implements one or more computer systems, such as servers, to perform various operations and interact with other devices and systems via data communication network 104. Delivery vehicle 108 may contain one or more computing devices capable of communicating with merchant 106 and/or remote storage device 110. Similarly, storage device 110 may contain one or more computing devices capable of communicating with merchant 106 and delivery vehicle 108.

Merchant 106 includes an order management system 112, a delivery management system 114, and a database 116. Order management system 112 receives orders from multiple users 102 and manages the received orders. Delivery management system 114 manages the delivery of items in various orders received by order management system 112. The database 116 stores data used by order management system 112 and delivery management system 114, such as user data, item data, order data, delivery data, and the like. Additional details regarding delivery management system 114 are provided herein.

Although one delivery vehicle 108, one remote storage device 110, and one merchant 106 are shown in FIG. 1, particular environments 100 may include any number of delivery vehicles and remote storage devices coupled to any number of merchants.

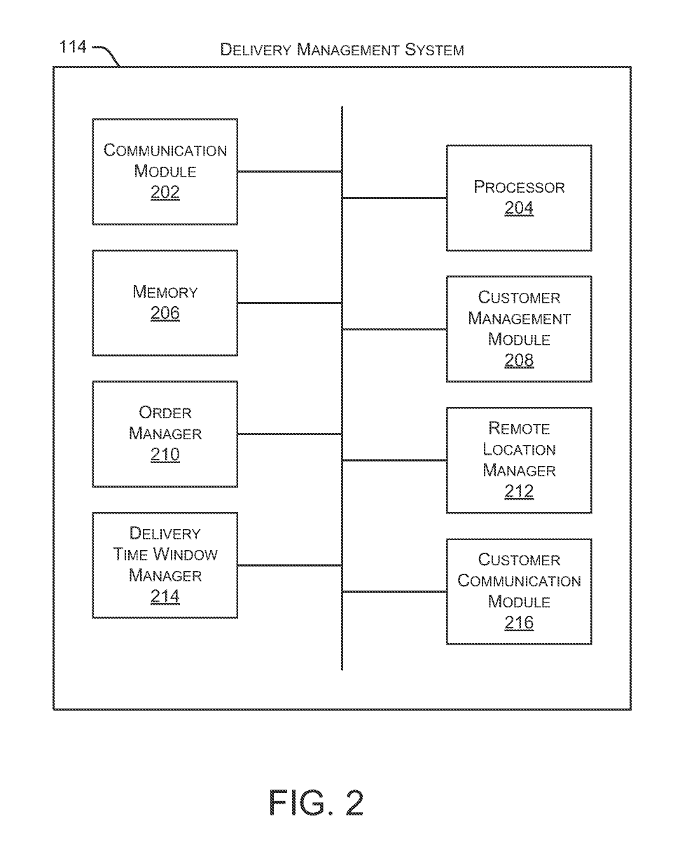

FIG. 2 is a block diagram depicting an embodiment of delivery management system 114. Delivery management system 114 includes a communication module 202, a processor 204, and a memory 206. Communication module 202 allows delivery management system 114 to communicate with other devices and systems, such as user device 102, delivery vehicle 108, remote storage device 110, and the like. Processor 204 executes various instructions to implement the functionality provided by delivery management system 114. Memory 206 stores these instructions as well as other data used by processor 204 and other modules contained in delivery management system 114.

Delivery management system 114 also includes a customer management module 208 that manages customer information, customer orders, customer deliveries, and the like. An order manager 210 manages various aspects of an order, such as receiving orders, determining order volume, determining order weight, and scheduling delivery of orders to a remote storage device 110, as specified by the user. Delivery management system 114 also includes a remote location manager 212, which manages the delivery and storage of items in any number of orders to any number of remote storage devices 110. For example, when an order is placed for delivery, remote location manager 212 determines the sizes and types of lockers (e.g., refrigerated, frozen or temperature-independent) available at a particular remote pick-up location. Based on the sizes and types of items in the order, remote location manager 212 determines how many lockers of each type are needed to store the items in the order. Remote location manager 212 also manages access codes assigned to lockers at remote pick-up locations. These access codes are provided to the appropriate users to access their order items while restricting unauthorized access to the lockers.

Delivery management system 114 further includes a delivery time window manager 214 that handles the scheduling of deliveries from the merchant to the remote pick-up locations. Delivery time window manager 214 also determines a time window during which the user's items will be at the remote pick-up location and available for pick-up by the user. Delivery time window manager 214 also manages available space on delivery vehicles 108 that deliver items to remote storage devices 110. A customer communication module 216 interacts with one or more customers regarding orders, remote storage device access codes, delivery time windows, and the like.

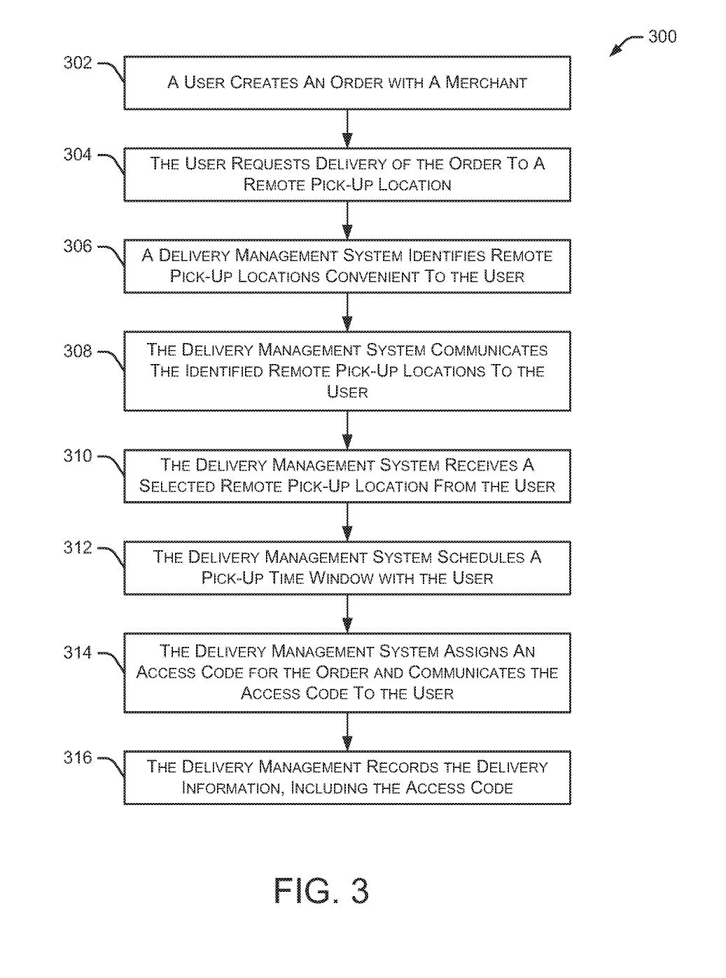

FIG. 3 is a flow diagram depicting an embodiment of a method 300 for scheduling delivery of an order to a remote pick-up location. Initially, a user creates an order with a merchant at 302. The order may contain a variety of items, including refrigerated items, frozen items, and temperature-independent items. For example, a single grocery order may contain all three of these types of items. After placing the order, the user requests delivery of the order to a remote pick-up location at 304. As discussed herein, the remote pick-up location contains multiple storage devices (also referred to as “lockers”). In some embodiments, the remote pick-up location contains one group of lockers that can accommodate refrigerated items, a second group of lockers that can accommodate frozen items, and a third group of lockers that can accommodate temperature-independent items (i.e., items that are not frozen or refrigerated).

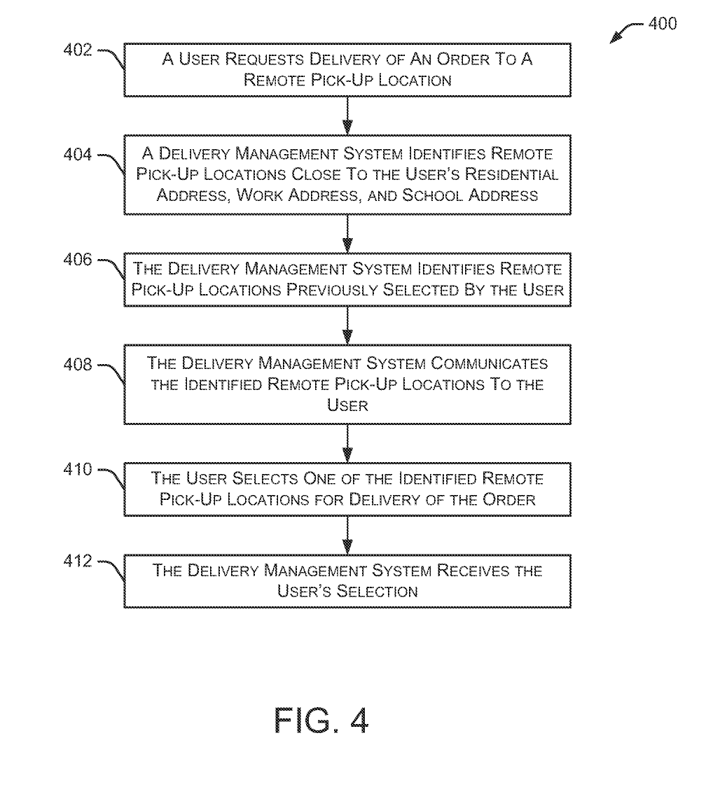

Method 300 continues as a delivery management system identifies at 306 remote pick-up locations convenient to the user. The delivery management system communicates the identified remote pick-up locations to the user at 308 and receives a selected remote pick-up location from the user at 310. A user may select the remote pick-up location, for example, based on the proximity to the user's home, work or school. In other situations, the user may select a remote pick-up location that is close to the user's travels that day (e.g., close to other stores the user is visiting or close to a friend's house). Additional details regarding the identification and selection of the remote pick-up location are provided herein with respect to FIG. 4.

After receiving a user selection of a remote pick-up location, the delivery management system schedules a pick-up time window with the user at 312. The pick-up time window is the period of time during which the user's order will be available for pick-up by the user from the remote pick-up location. In some embodiments, the pick-up time window is approximately 4-8 hours. However, the pick-up time window can be any duration as determined by the merchant and/or the user.

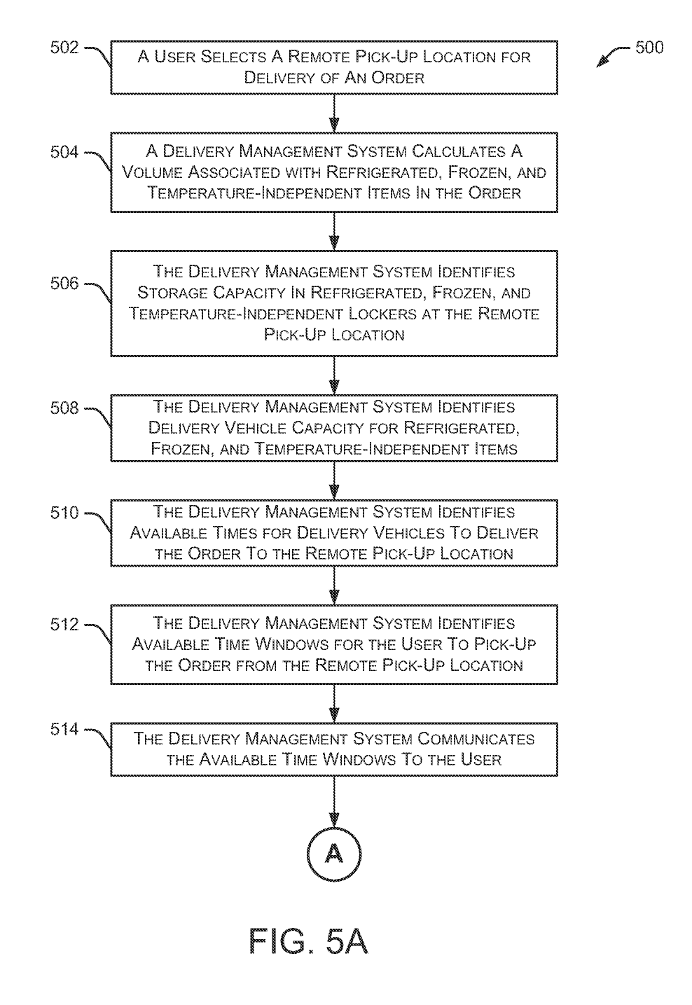

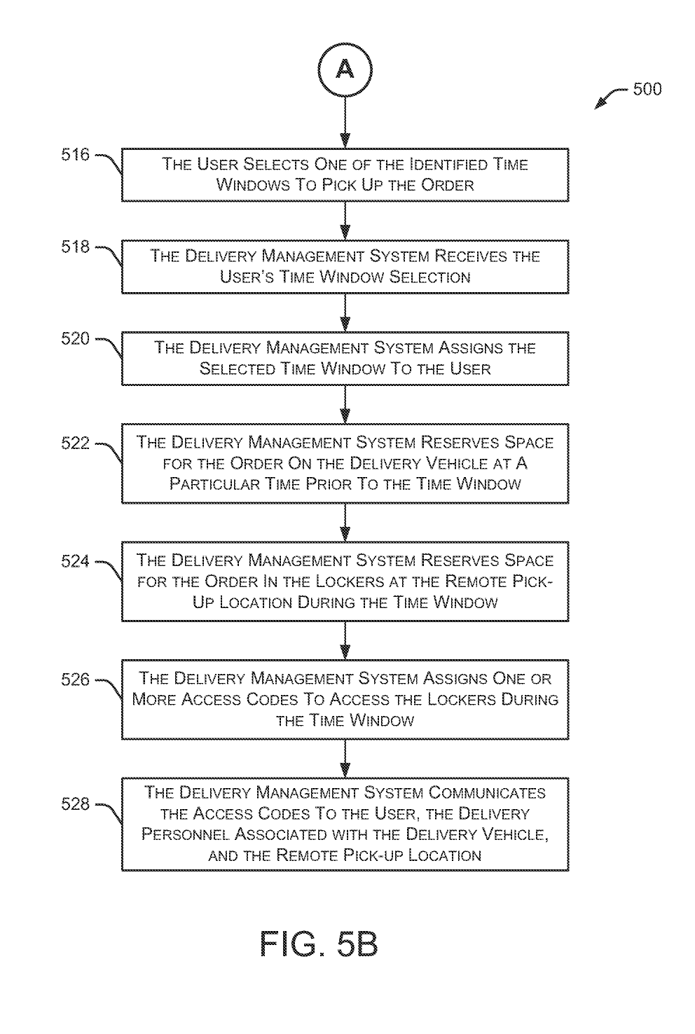

The delivery management system assigns an access code for the order and communicates the access code to the user at 314. The access code allows the user to access items in the lockers at the remote pick-up location. In some embodiments, a single access code opens all lockers containing the items in the user's order (e.g., a single access code opens a refrigerated locker, a freezer locker, and a temperature-independent locker). In other embodiments, separate access codes are used for each locker (e.g., a first access code opens a refrigerated locker, a second access code opens a freezer locker, and a third access code opens a temperature-independent locker). Method 300 continues as the delivery management system records the delivery information, including the access code (or codes) at 316. Additional details regarding the scheduling of a pick-up time window are provided herein with respect to FIGS. 5A and 5B.

FIG. 4 is a flow diagram depicting an embodiment of a method 400 for selecting a remote pick-up location. Initially, a user requests delivery of an order to a remote pick-up location at 402. A delivery management system identifies remote pick-up locations close to the user's residential address, work address, and school address at 404. The delivery management system also identifies at 406 remote pick-up locations previously selected by the user (e.g., selected by the user for delivery of previous orders). Method 400 continues as the delivery management system communicates the identified remote pick-up locations to the user at 408. The user selects one of the identified remote pick-up locations for delivery of the order at 410. In alternate embodiments, the user may request the identification of additional remote pick-up locations in a specific geographic area. Finally, the delivery management system receives the user's selection at 412.

FIGS. 5A and 5B represent a flow diagram depicting an embodiment of a method 500 for determining available pick-up time windows for an order. Initially, a user selects a remote pick-up location for delivery of an order at 502. A delivery management system calculates a volume associated with refrigerated, frozen, and temperature-independent items in the order at 504. In some embodiments, each item in the order has associated metadata that indicates whether the item is refrigerated, frozen or temperature-independent. Additionally, each item has associated metadata that identifies the item's dimensions and the item's volume. The delivery management system then identifies at 506 storage capacity in refrigerated, frozen, and temperature-independent lockers at the selected remote pick-up location. The delivery management system also identifies at 508 delivery vehicle capacity for refrigerated, frozen and temperature-independent items at various times. Based on the storage capacity identified at 506 and the delivery vehicle capacity identified at 508, method 500 identifies available times for delivery vehicles to deliver the order to the remote pick-up location at 510.

The delivery management system then identifies available time windows for the user to pick-up the order from the remote pick-up location at 512. The time windows are selected to be after a scheduled delivery of the order to the remote pick-up location by the delivery vehicle. Method 500 continues as the delivery management system communicates the available time windows to the user at 514. The user selects one of the available time windows at 516. In alternate embodiments, the user may request the identification of additional time windows for the order.

The delivery management system receives the user's selection of a time window at 518 and assigns the selected time window to the user at 520. The delivery management system reserves space for the order on the appropriate delivery vehicle at a particular time prior to the time window at 522. In some embodiments, the delivery vehicle has separate spaces (or compartments) for refrigerated items, frozen items, and temperature-independent items. In other embodiments, separate delivery vehicles are used for each of the three types of items. When reserving space for the order on the delivery vehicle, the delivery management system reserves appropriate space in the refrigerated portion of the delivery vehicle, the freezer portion of the delivery vehicle, and the temperature-independent portion of the delivery vehicle.

Method 500 continues as the delivery management system reserves space for the order in the lockers at the remote pick-up location during the time window at 524. In some embodiments, each locker has separate spaces (or compartments) for refrigerated items, frozen items, and temperature-independent items. In other embodiments, separate lockers are used for each of the three types of items. When reserving space for the order in the lockers, the delivery management system reserves appropriate space in the refrigerated portion of the locker, the freezer portion of the locker, and the temperature-independent portion of the locker. The delivery management system then assigns one or more access codes to access the lockers during the time window at 526. In some embodiments, a single access code is used to access all three portions of the locker (i.e., the refrigerated portion of the locker, the freezer portion of the locker, and the temperature-independent portion of the locker). The delivery management system also communicates the access codes to the user, delivery personnel associated with the delivery vehicle, and the remote pick-up location at 528. The access codes are used by the delivery personnel to access the lockers at the remote pick-up location when delivering the items into the lockers. In some embodiments, the delivery personnel use separate access codes for each order. In other embodiments, the delivery personnel use a single access code to access all lockers associated with all of the orders being delivered by the delivery personnel at the particular remote pick-up location.

The access codes provided to the user have a valid time window that corresponds to the pick-up time window. Thus, the access codes are valid during the time that the user is scheduled to pick-up their order. After the scheduled time window expires, the access codes are no longer valid and the user cannot access the lockers. In this situation, the user may contact the merchant to request issuance of new access codes.

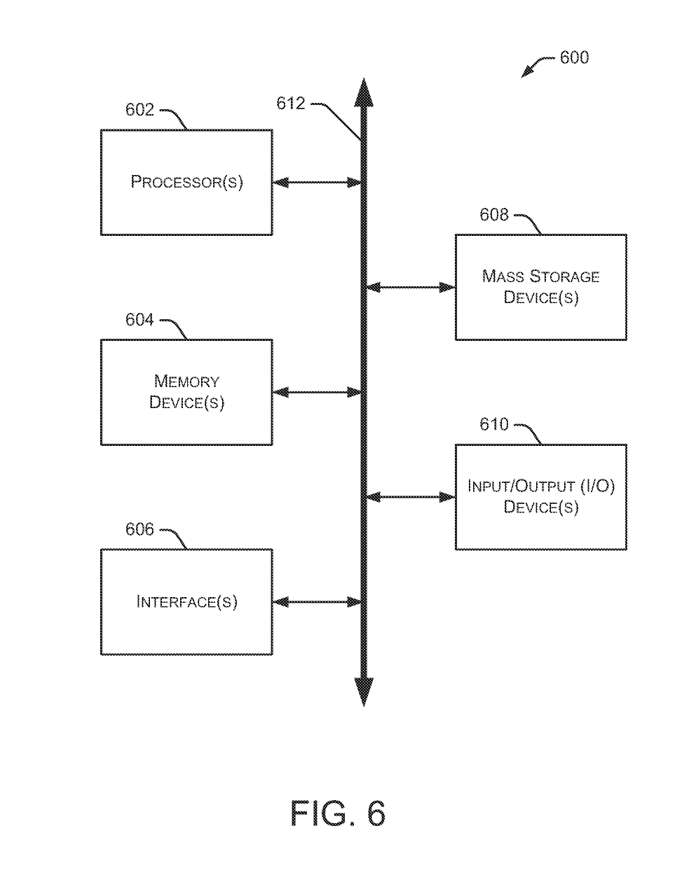

FIG. 6 is a block diagram depicting an example computing device 600. Computing device 600 may be used to perform various procedures, such as those discussed herein. Computing device 600 can function as a server, a client or any other computing entity. Computing device 600 can be any of a wide variety of computing devices, such as a desktop computer, a notebook computer, a server computer, a handheld computer, a tablet, and the like.

Computing device 600 includes one or more processor(s) 602, one or more memory device(s) 604, one or more interface(s) 606, one or more mass storage device(s) 608, and one or more Input/Output (I/O) device(s) 610, all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM)) and/or nonvolatile memory (e.g., read-only memory (ROM)). Memory device(s) 604 may also include rewritable ROM, such as Flash memory.

Mass storage device(s) 608 include various computer readable media, such as magnetic tapes, magnetic disks, optical disks, solid state memory (e.g., Flash memory), and so forth. Various drives may also be included in mass storage device(s) 608 to enable reading from and/or writing to the various computer readable media. Mass storage device(s) 608 include removable media and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Interface(s) 606 include various interfaces that allow computing device 600 to interact with other systems, devices, or computing environments. Example interface(s) 606 include any number of different network interfaces, such as interfaces to local area networks (LANs), wide area networks (WANs), wireless networks, and the Internet.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving a request from a user to deliver an order to a remote pick-up location, wherein the order includes a first item requiring refrigeration and a second item that is temperature-independent;
identifying, using one or more processors, a plurality of remote pick-up locations convenient to the user;
communicating the plurality of remote pick-up locations to the user;
receiving, from the user, a selection of a particular remote pick-up location;
scheduling, using the one or more processors, delivery of the order to the particular remote pick-up location at a delivery time;
notifying the user of a pick-up time window to access the order at the particular remote pick-up location, the pick-up time window subsequent to the delivery time;
generating, using the one or more processors, an access code associated with the order, the access code allowing the user to access the order at the particular remote pick-up location during the pick-up time window; and
communicating the access code to the user.

2. The method of claim 1, further comprising communicating the access code to a storage device at the particular remote pick-up location.

3. The method of claim 1, wherein the access code is valid during the pick-up time window.

4. The method of claim 1, wherein scheduling delivery of the order includes:
determining a volume associated with refrigerated items in the order;
determining a volume associated with frozen items in the order;
determining a volume associated with temperature-independent items in the order; and
determining available refrigerated, frozen, and temperature-independent storage capacity at the particular remote pick-up location.

5. The method of claim 4, wherein scheduling delivery of the order further includes determining refrigerated, frozen, and temperature-independent vehicle capacity on a plurality of delivery vehicles.

6. The method of claim 1, wherein identifying a plurality of remote pick-up locations convenient to the user includes:
identifying remote pick-up locations close to the user's residential address; and
identifying remote pick-up locations close to the user's work address.

7. The method of claim 1, wherein identifying a plurality of remote pick-up locations convenient to the user includes identifying remote pick-up locations previously selected by the user.

8. The method of claim 1, wherein the order further includes a third item requiring storage in a freezer.

9. The method of claim 1, further comprising reserving space for the order in at least one locker at the selected remote pick-up location based on a volume of the items requiring refrigeration and a volume of the items that are temperature-independent.

10. The method of claim 1, further comprising reserving space for the order on a delivery vehicle based on a volume of the items requiring refrigeration and a volume of the items that are temperature-independent.

11. The method of claim 1, further comprising invalidating the access code at the end of the pick-up time window.

12. A method comprising:
receiving a request from a user to deliver an order to a remote pick-up location, wherein the order includes a first item requiring refrigeration, a second item that requires storage in a freezer, and a third item that is temperature-independent;
identifying, using one or more processors, a plurality of remote pick-up locations convenient to the user;
communicating the plurality of remote pick-up locations to the user;
receiving, from the user, a selection of a particular remote pick-up location;
determining a volume associated with refrigerated items in the order;
determining a volume associated with frozen items in the order;
determining a volume associated with temperature-independent items in the order;
determining available refrigerated, frozen, and temperature-independent storage capacity at the selected remote pick-up location; and
scheduling, using the one or more processors, delivery of the order to the selected remote pick-up location at a delivery time based on the volume associated with refrigerated items in the order, the volume associated with frozen items in the order, the volume associated with temperature-independent items in the order, and the storage capacity at the selected remote pick-up location.

13. The method of claim 12, further comprising notifying the user of a pick-up time window to access the order at the selected remote pick-up location.

14. The method of claim 13, further comprising:
generating an access code associated with the order, the access code allowing the user to access the order at the selected remote pick-up location during the pick-up time window; and
communicating the access code to the user.

15. The method of claim 14, further comprising communicating the access code to a storage device at the selected remote pick-up location.

16. The method of claim 14, wherein the access code is valid during the pick-up time window.

17. The method of claim 12, wherein scheduling delivery of the order further includes determining refrigerated, frozen, and temperature-independent vehicle capacity on a plurality of delivery vehicles.

18. The method of claim 12, wherein identifying a plurality of remote pick-up locations convenient to the user includes at least one of:
identifying remote pick-up locations close to the user's residential address;
identifying remote pick-up locations close to the user's work address; and
identifying remote pick-up locations previously selected by the user.

19. An apparatus comprising:
a memory to store data associated with an online order; and
one or more processors coupled to the memory, the one or more processors configured to:
receive a request from a user to deliver an order to a remote pick-up location, wherein the order includes a first item requiring refrigeration and a second item that is temperature-independent;
identify a plurality of remote pick-up locations convenient to the user;
communicate the plurality of remote pick-up locations to the user;
receive, from the user, a selection of a particular remote pick-up location;
schedule delivery of the order to the particular remote pick-up location at a delivery time;
notify the user of a pick-up time window to access the order at the particular remote pick-up location, the pick-up time window subsequent to the delivery time;
generate an access code associated with the order, the access code allowing the user to access the order at the particular remote pick-up location during the pick-up time window; and
communicate the access code to the user.

20. The apparatus of claim 19, the one or more processors are further configured to:
determine a volume of refrigerated items in the order;
determine a volume of frozen items in the order;
determine a volume of temperature-independent items in the order;
determine available refrigerated, frozen, and temperature-independent storage capacity at the particular remote pick-up location; and
select a delivery time based on the volume of the refrigerated items in the order, the volume of the frozen items in the order, the volume of the temperature-independent items in the order, and the available storage capacity at the particular remote pick-up location.
